(19) United States
(12) Patent Application Publication
(10) Pub. No.: US 2014/0089560 A1
(43) Pub. Date: Mar. 27, 2014

(54) MEMORY DEVICES AND METHODS HAVING WRITE DATA PERMUTATION FOR CELL WEAR REDUCTION

(71) Applicants: Ravi Sunkavalli, Cupertino, CA (US); Malcolm Wing, Palo Alto, CA (US)

(72) Inventors: Ravi Sunkavalli, Cupertino, CA (US); Malcolm Wing, Palo Alto, CA (US)

(73) Assignee: Adesto Technologies Corporation, Sunnyvale, CA (US)

(21) Appl. No.: 13/626,721

(22) Filed: Sep. 25, 2012

(51) Int. Cl. G06F 12/00

(52) U.S. Cl. 711/103; 711/E12.008

(57) ABSTRACT

A memory system can include a plurality of memory elements each comprising a memory layer having at least one layer programmable between at least two different impedance states; a data input configured to receive multi-bit write data values; and a permutation circuit coupled between the memory elements and the data input, and configured to repeatedly permute the multi-bit write data values prior to writing such data values into the memory elements.

### TECHNICAL FIELD

The present disclosure relates generally to memory devices, and more particularly to memory devices having storage elements that can be subject to wear.

### BACKGROUND

Conventional memory devices based on a programmable impedance layer, such as conductive bridging random access memory (CBRAMs), can be subject to “wear”. As a programmable impedance element is used (e.g., read, programmed and/or erased) a certain number of times, its performance can begin to deteriorate (e.g., its data retention can fall, its range of impedance can grow too large, or it may take too long to program to a particular state). Due to the physical alignment of data units (e.g., bytes, words, double words, etc.) memory elements can be subject to uneven use on a bit position basis.

FIG. 16 is a diagram representing wear on a bit location basis for data units of different sizes. Section 1601 shows a collection of bits divided on a double-word type basis. Row 1601-0 shows the four bytes (Byte 3 to Byte 0) of a double-word extending from a least significant bit (lsb) to a most significant bit (msb). Row 1601-1 shows wear levels corresponding to the double-word, where greater hatching corresponds to greater wear. As shown, the less significant a bit, the greater the wear. Section 1603 shows a same number of bits divided on a word basis. Row 1603-0 shows the two bytes (Byte 0/1) corresponding to each word. Row 1603-1 shows wear levels for each word. Section 1605 shows a same number of bits divided on a byte basis. Row 1605-0 shows the individual bytes (each labeled Byte 0). Row 1605-1 shows wear levels for each byte.

Regions 1607-0/1 show high wear bit positions that can arise during the operation of the memory device. Such high wear bit positions can limit the lifetime of a device and/or necessitate “healing” or other types of operation intended to undue the adverse affect of wear.

### BRIEF DESCRIPTION OF THE DRAWINGS

FIG. 1 is a block schematic diagram of a memory device according to an embodiment.

FIG. 2 is a diagram showing a side cross sectional view of a memory element that can be included in embodiments.

FIGS. 3A to 3F are diagrams showing bit shifting according to embodiments.

FIGS. 4A to 4C are a sequence of block schematic diagrams showing permutation change operations according to an embodiment.

FIGS. 5A to 5C are a sequence of block schematic diagrams showing permutation change operations according to another embodiment.

FIGS. 6A to 6D are a sequence of block schematic diagrams showing permutation change operations according to a further embodiment.

FIG. 7 is a block schematic diagram of a memory device having bit scrambling according to an embodiment.

FIGS. 8A and 8B show one particular type of bit scrambling that can be included in embodiments.

FIG. 9A is a block schematic diagram of a memory device having multi-bit encoding to larger bit widths according to an embodiment.

FIG. 9B shows one particular type of permutation where data values are written into locations having spare bits.

FIG. 10 is a block schematic diagram of a memory device having permutations that vary error code positions according to an embodiment.

FIGS. 11A and 11B are diagrams showing permutation using error codes according to two particular embodiments.

FIG. 12 is a block schematic diagram of a memory device that can store permutation data for recall, according to an embodiment.

FIG. 13 is a flow diagram of a method according to an embodiment.

FIG. 14 is a flow diagram of a method according to another embodiment.

FIG. 15 is a flow diagram of a method according to a further embodiment.

FIG. 16 is a diagram showing high wear regions that can occur in a conventional memory device.

### DETAILED DESCRIPTION

Embodiments disclosed herein show memory devices and methods that can permute bit values of write data for a more even distribution wear over bit locations. Such permutation can extend the lifetime of a memory device and/or extend the amount of time between heal (or other) types of operations intended to reverse wear affects.

In the embodiments below, like sections are referred to by the same reference character but with the leading digit(s) corresponding to the figure number.

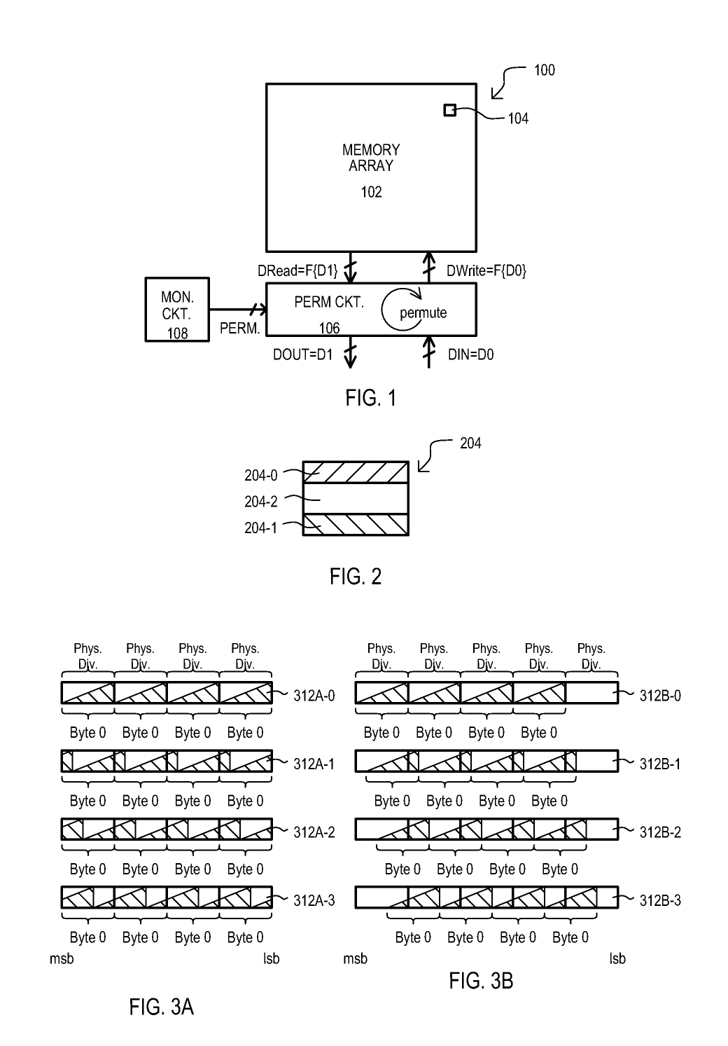

FIG. 1 shows a memory device 100 according to one embodiment in a block schematic diagram. A memory device 100 can include a memory cell array 102, a permutation circuit 106, a monitor circuit 108, and a write data input 110. A memory cell array 102 can include a number of memory cells (one shown as 104) that store data based on a programmable impedance layer. A memory cell 104 can be subject to wear, degrading with use and/or over time.

A memory cell 104 can include various types of memories, including phase change memory (PCM) and electrically erasable and programmable read only memories (EEPROMs), including “flash” NAND and NOR types. In particular embodiments, memory cells can be a solid electrolyte based, having one or more memory elements with at least one solid electrolyte layer programmable between at least two different impedance states. A memory cell 104 can include but one memory element, a memory element in combination with one or more active devices (e.g., transistors), and/or multiple memory elements. An impedance state can be a static state (i.e., the element impedance remains constant over a period of time) or dynamic state (i.e., the element impedance changes over time and/or changes in a sensing operation).

A permutation circuit 106 can receive write data values (DIN), and permute such values as they are written into memory cell array 102. A type of permutation performed on write data can vary according to a permutation select value PERM. Thus, a permutation circuit 106 can transform an input data value (D0) having an initial bit order, into a written data value DWrite that is a permutation of the initial bit order. It is understood that “permutation” as described herein does not necessarily imply written data values (data values applied to memory elements) are the same size as input data values. While in some embodiments a bit size of data values applied to a memory cell array 102 can be the same as received write data, in other embodiments data values applied to a memory cell array can be larger than received input data values (e.g., input data values of m-bits can be encoded into written data values of n-bits, where n>m, or data values of m-bits can be written into differing ones of n-bits). Further, permutation does not necessarily require only a change in bit order position, as some embodiments can permute bits via an encoding/decoding scheme.

A monitor circuit 108 can change a permutation select value PERM. according to predetermined conditions. In some embodiments, such conditions can be wear conditions. Wear conditions can vary according to a particular type of memory element, and in particular embodiments, can correspond to write operations and/or the passage of time. However, in other embodiments conditions can simply be the passage of time or a number of operations. As but one example, permutations can be periodically switched based on a timing clock. As but another example, permutations can be switched based on a number of accesses (e.g., reads, writes, etc.). This can include combinations of accesses with one type of access being weighted more than another (e.g., a write accesses can trigger a permutation faster than read accesses). In still other embodiments, a particular type of access can trigger a permutation change (e.g., a certain number of writes triggers a permutation change).

A permutation circuit 108 can also include a read data path that reverses permutations to present an output data value having the desired bit order. Thus, permutation circuit 108 can receive data values (Dread) read from memory cell array 102, which can be a data value D1 permuted according to a current permutation choice, and undo such a permutation to present an output data value DOUT.

In some embodiments permutation circuits and/or monitor circuits can be formed in a same integrated circuit device as a corresponding memory array. That is, permutation is performed “on-board” a memory device. However, in other embodiments, permutation and wear monitoring functions can be performed by device(s) separate from that containing the memory cells. As but a few examples, permutation can be performed by a memory controller and/or processor executing application software.

FIG. 2 is diagram of a memory element 204 that can be included in embodiments. A memory element 204 can be a two terminal element having one or more programmable impedance layers 204-2 disposed between a first electrode 204-0 and a second electrode 204-1. By application of an electric field across the electrodes (204-0/1), an impedance state of a programmable impedance layer(s) 204-2 can change. In particular embodiments, a programmable impedance layer can be a solid electrolyte, and application of one electric field can give rise to conductive regions by operation ion conduction to lower a resistance of an element. Application of a reverse electric field can dissolve such conductive regions, can which results in a higher resistance in the element.

It is understood that FIG. 2 shows but one type of memory element that can be included in embodiments. Alternate embodiments can include, but are not limited to PCM and EEPROM type memories.

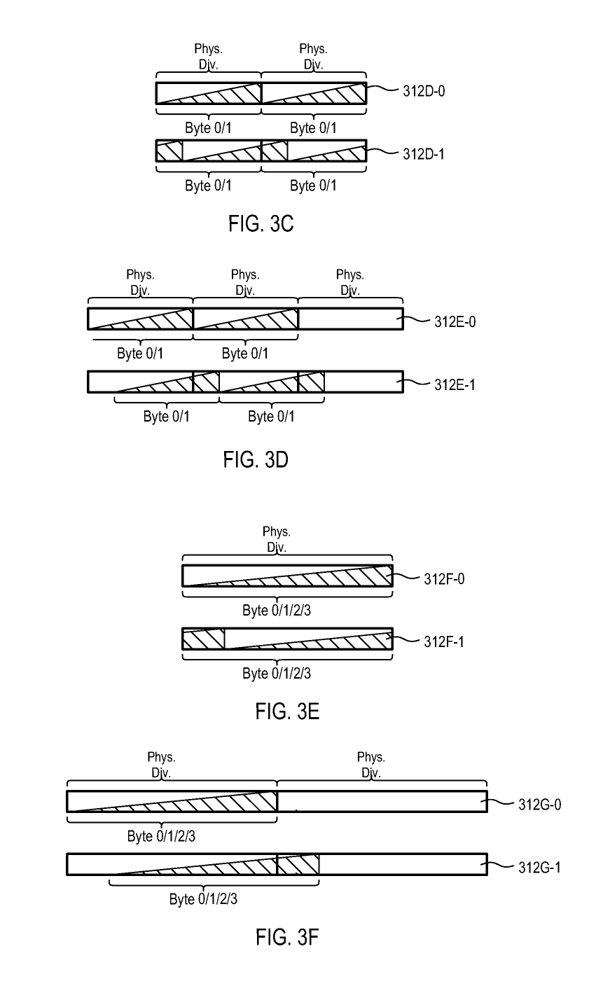

According to some embodiments different permutations can include a shifting of bits by increasing amounts in a particular direction. FIGS. 3A to 3G show different variations on bit shifting permutations according to embodiments.

FIGS. 3A and 3B show sequences of bit shifts along byte divisions according to two embodiments. FIGS. 3A/B show physical divisions (Phys. Div.) of a memory cell array as bold boxes. Logical data (i.e., bytes) are shown as Byte 0.

FIG. 3A shows a “wrapping” bit shift embodiment. Row 312A-0 shows an initial bit permutation, which can be a conventional bit order where bits of a byte are positioned from a most significant bit to a least significant bit, going from left to right. Row 312A-1 shows a next permutation, in which bits are shifted from left to right, but with wrapping along the physical divisions. Consequently, least significant bits occupy the locations of most significant bits of the previous permutation. Rows 312A-2/3 show follow-on permutations that shift byte data further to the right each time. According to one embodiment, a permutation sequence can eventually return to an initial permutation (i.e., 312A-0), and the sequence can repeat.

FIG. 3B shows a non-wrapping bit shift embodiment. Row 312B-0 shows an initial bit permutation, which can be the same as that of FIG. 312A-0. However, FIG. 3B includes an additional physical group of byte. Row 312A-1 shows a next permutation, in which bits are shifted from left to right. There is no wrapping, so bits can be shifted into an adjacent physical division. That is, least significant bits can occupy locations of most significant bits of the adjacent physical division. Rows 312A-2/3 show follow-on permutations. According to one embodiment, a permutation sequence can eventually return to an initial permutation (i.e., 312B-0), and the sequence can repeat.

FIG. 3C shows a wrapping bit shift embodiment like that of FIG. 3A, but along word divisions (i.e., two bytes). FIG. 3D shows a non-wrapping bit shift embodiment like that of FIG. 3B, but along word divisions.

FIG. 3E shows a wrapping bit shift embodiment like that of FIG. 3A, but along a double word division (i.e., four bytes). FIG. 3F shows a non-wrapping bit shift embodiment like that of FIG. 3B, but along double word divisions.

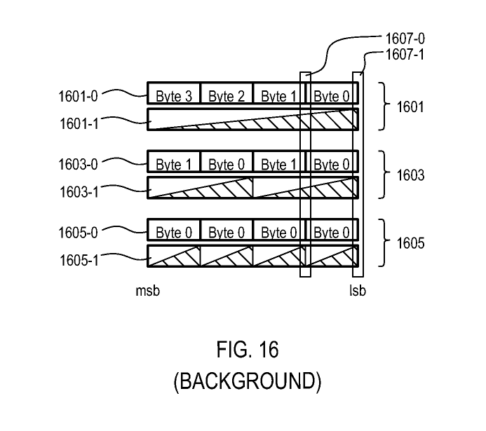

By shifting bits in this manner, wear can be more evenly distributed to avoid high wear bit locations, as shown in FIG. 16.

Permutation of bits can occur along any suitable boundary. While embodiments herein describe permutation along byte, double-byte, word, and double word division, other embodiments can execute permutations along larger or smaller bit divisions. For example, in some embodiments can permutation can occur along 256 bit boundaries.

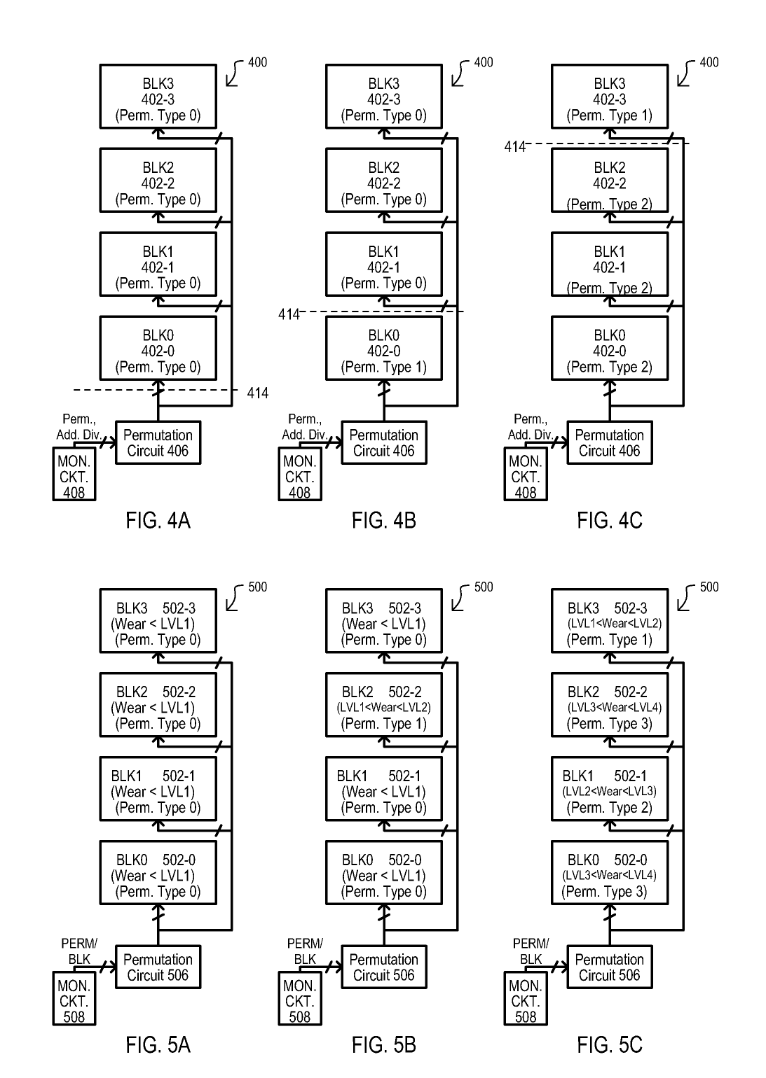

According to some embodiments, a memory device can include memory cells organized into groups, with different permutations being applied to different groups at the same time. FIGS. 4A to 4C show one such embodiment.

FIGS. 4A to 4C show a sequence of block schematic diagrams of a memory device 400. Memory device 400 can have memory cells organized into blocks (402-0 to -3), a permutation circuit 406, and a monitor circuit 408. Blocks (402-0 to -3) can be some physical division of memory cells. A block (402-0 to -3) can be divided along column or row directions, and can include as little as one row and multiple columns. In one particular embodiment, each block (402-0 to -3) can be separately addressable.

A permutation circuit 406 can apply different permutation types to different blocks (402-0 to -3) according to values provided from monitor circuit 408. Monitor circuit (402-0 to -3) can alter a permutation applied to a block based on various criteria as described herein, or equivalents (e.g., based on accesses, wear, time, etc.). In the very particular embodiment shown, permutations can change based on an address indication (Add. Div.) 414.

FIG. 4A shows a memory device 400 in an initial state. All blocks (402-0 to -3) can have a same permutation type (Perm. Type 0). In the very particular embodiment shown, and address indication 414 can be below a starting point of an address space, thus an address space for the blocks (402-0 to -3) is not divided.

FIG. 4B shows a memory device 400 after a first permutation change occurs. By operation of monitor circuit 408, an address indication 414 can advance to divide an address space into two regions. In the very particular embodiment shown, addresses below address indication 414 (BLK0 402-0) can have a new permutation type (Perm. Type 1). Thus, accesses to BLK0 402-0 can permute data values according to a next permutation type (Perm. Type 1), while accesses to the remainder of the blocks (BLK0 402-1, 402-2, and 402-3) can permute data according to an initial permutation type (Perm. Type 0).

In one particular embodiment, a device 400 can continue to advance an address indication 414 until all blocks are accessed according to a new permutation type, returning to the position shown in FIG. 4A. Device 400 can then advance as shown in FIG. 4B, applying a next permutation to block 402-0. This sequence can repeat with each new permutation type.

FIG. 4C shows a memory device 400 at the end of a second sequence that changes a permutation type. All blocks have previously been subject to a permutation type (Perm. Type 1). An address indication 414 has advanced so that blocks 402-0 to -2 can have permutation type Perm. Type 2, while block 402-3 can permute data values according to the previous permutation type (Perm. Type 1).

While the embodiment of FIGS. 4A to 4C shows the application of different permutation types according to a predetermined sequence, other embodiments can alter permutation types based on actual use of a block. FIGS. 5A to 5C show one example of such an embodiment.

FIGS. 5A to 5C show a sequence of block schematic diagrams of a memory device 500. Memory device 500 can have sections like those of FIGS. 4A to 4C. However, a permutation circuit 506 can select a permutation type for individual blocks, according to control data PERM/BLK provided from a monitor circuit 508. In the very particular embodiment shown, permutation types are changed once a wear level for a block is reached.

FIG. 5A shows a memory device 500 in an initial state. All blocks (502-0 to -3) can be determined to have a wear level below a first threshold (Wear<LVL1). Accordingly, each block (502-0 to -3) can have a same permutation type (Perm. Type 0).

FIG. 5B shows a memory device 500 when a first permutation change occurs. Monitor circuit 508 determines that a wear level of block 502-2 exceeds a first limit (LVL1<Wear<LVL2), and provides control values PERM/BLK that direct permutation circuit 506 to apply a new permutation type (Perm. Type 1), while the remaining blocks 502-0,-1,-3 (which have a lower wear level Wear<LVL1) continue to have an initial permutation type (Perm. Type 1).

FIG. 5C shows a memory device 500 as blocks (502-0 to -3) continue to have varying levels of wear, and hence different permutation types.

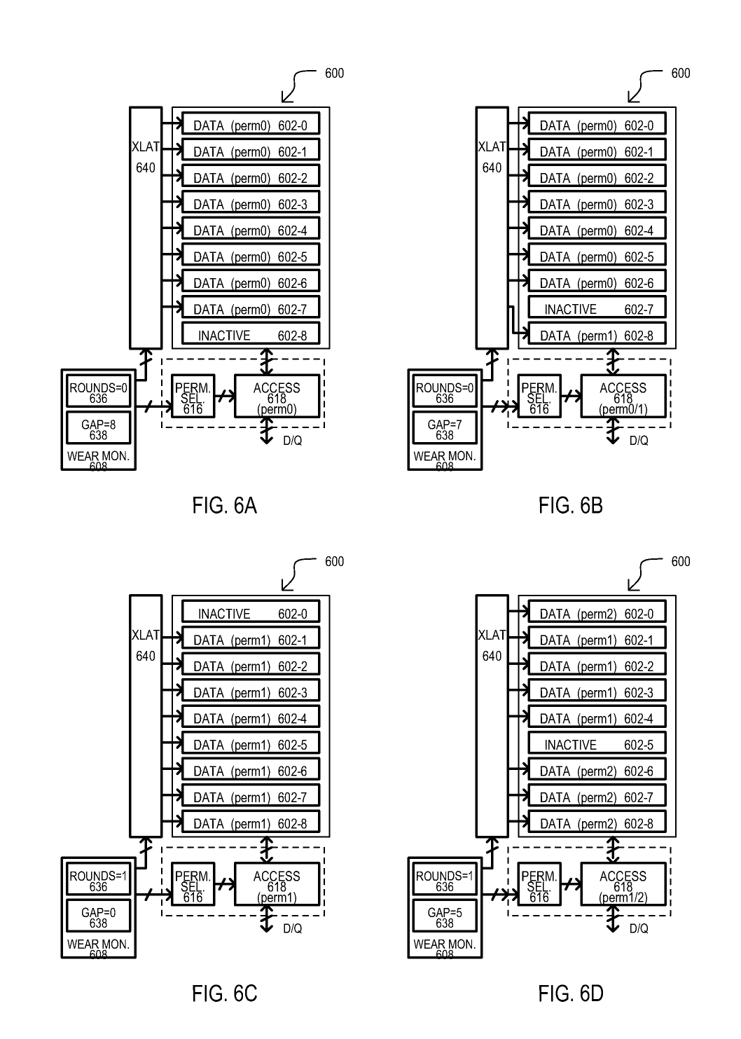

While embodiments above have shown application of different permutation types by dividing an address space and/or applying different permutations to different blocks, in particular embodiments, permutation can be used in combination with a “start-gap” type rotation. On such embodiment is shown in FIGS. 6A to 6D.

FIGS. 6A to 6D show a sequence of block schematic of a memory device 600 having a number of physical blocks 602-0 to -8, an address translator 640, monitor circuit 608, and permutation circuit 606. Physical blocks (602-0 to -8) can include memory cells with one or more elements, as described herein or equivalents. In the embodiment shown, at any given time, eight blocks can be active, while one block is a spare block.

An address translator 640 can receive logical addresses, and translate them into physical addresses for accessing physical blocks (602-0 to -8). However, during standard read and write operations, an address translator 640 can enable access to eight physical blocks, while preventing access to any spare block(s).

A memory device 600 can assign a physical block as a spare block according to a predetermined order. Once all blocks have served as a spare block, the memory device 600 can return to the first block and repeat the sequence. Within monitor circuit 608, a count register 636 can track how many times every block (602-0 to -8) has served as a spare block. A gap register 638 can indicate which block is currently a spare block. A permutation type can change according to a gap position.

Permutation circuit 606 can include a permutation select section 616 and an access section 606. A permutation select circuit 616 can determine a permutation type applied to data values based on control signals received from monitor circuit 608. An access section 606 can permute write data applied to blocks (602-0 to -8), and “undo” such permutations as data are read from the blocks.

FIG. 6A shows a memory device 600 in an initial state. Blocks 602-0 to -7 can be active, while block 602-8 can be inactive (not accessible for reads/writes due to address mapping). Count register 636 can indicate all blocks have not served as a spare block (ROUND=0). Gap register 638 can indicate that block 602-8 is the spare block. A same permutation type (perm0) can be applied to all active blocks (602-0 to -7).

In the embodiment shown, it is assumed that memory device 600 automatically swaps an active and spare block after certain conditions have been met. Such conditions can include, but are not limited to: the execution of a certain number of operations, such as write operations, the passage of a predetermined amount of time, or combinations thereof.

FIG. 6B shows a memory device 600 following a first swapping between an active and spare block. Data previous stored in block 602-7 has been transferred to (previously spare) block 602-8, and block 602-7 is now a spare block. Count register 636 can continue to indicate ROUND=0, as only two of eight blocks have served as spares. Gap register 638 can indicate that block 602-7 is the spare block. With such a first swapping, the newly active block 902-8 can be subject to a new permutation type. Thus, as shown in FIG. 6B, blocks above the spare block (602-0 to -6) can continue have an initial permutation type (perm0), but block 602-8 below the spare block can have a new permutation type (perm1).

FIG. 6C shows a memory device 600 following an eighth swapping between an active and spare block. Data previous stored in block 602-0 has been transferred to (previously spare) block 602-1, and block 602-0 is now a spare block. Count register 636 can now indicate ROUND=1, as all blocks have now served as spare blocks once. Gap register 638 can indicate that block 602-0 is the spare block. Blocks 602-1 to −8 can all be subject to the new permutation type (perm1).

FIG. 6D shows a memory device 600 four swap operations following that of FIG. 6C. Count register 636 continues to indicate ROUND=1, and a gap register 638 can point to block 602-5 (GAP=5). Blocks 602-6 to -8 can have permutation type perm2, while block 602-0 to -4 can have permutation type perm1.

It is understood that FIGS. 6A to 6D show but one embodiment for automatically swapping active and spare blocks, and changing and assigning permutation type according to spare block position.

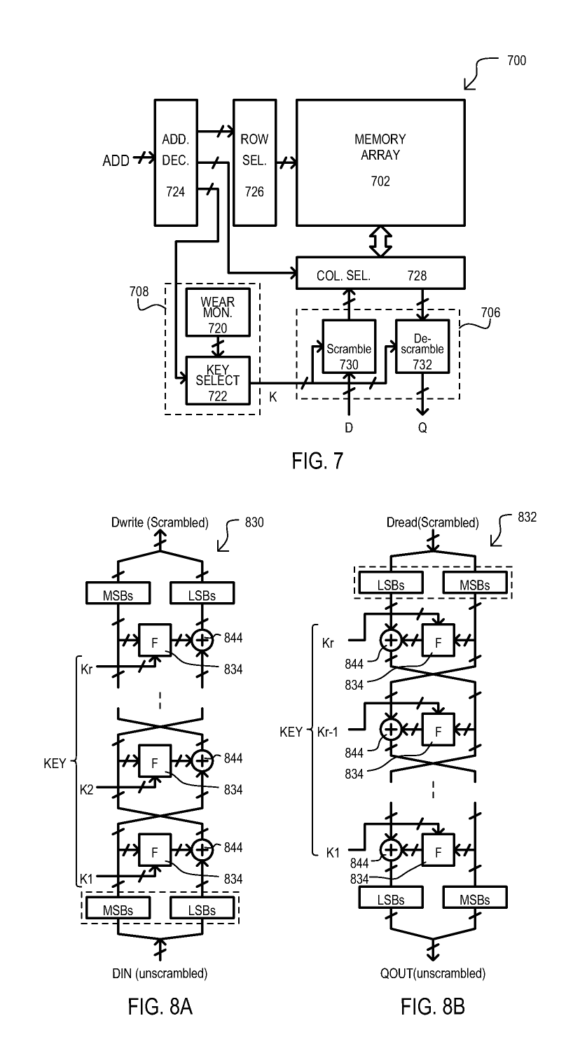

While embodiments can include permutations that shift bit positions in particular directions, other embodiments can “scramble” bit positions in a predetermined manner. In particular embodiments, bit positions can be changed in a pseudorandom fashion based on keys. A memory device according to one such embodiment is shown in FIG. 7.

FIG. 7 shows a memory device 700 according to one embodiment that can scramble data values going into a memory array, and de-scramble values coming out of the array. As in embodiments above, a memory device 700 can include a memory cell array 702, monitor circuit 708, and permutation circuit 706. FIG. 7 also shows an address decoder 724, row select circuit 726 and column select circuit 728.

A memory cell array 702 can include memory cells based on a programmable impedance layer, as described herein, or equivalents. In response to address data (ADD), an address decoder 724 can provide select signals for a row and column select circuits 726/728. Row and column select circuits 726/728 can access a data group for read or write (e.g., program, erase) operations. A data group can be a suitable collection of bits (e.g., nibbles, bytes, words, double-words, pages, etc.).

A monitor circuit 708 can include a wear monitor section 720 and a key select section 722. A wear monitor section 720 can make a determination that a permutation is to occur. In some embodiments, a wear monitor section 720 can include address data, and enable more than one permutation type to occur in memory array 702 at the same time (e.g., along address divisions, per block etc.). A key select section 722 can provide different scrambling keys to permutation circuit 706 to enable changes in the scrambling of bits (i.e., different bit position permutations). Keys (K) provided by key select section 722 can be stored by memory device 700, generated by memory device 700, or received as input data to memory device 700. In the particular embodiment shown, a key select section 722 can receive address data from address decoder 724 to enable a key to be selected according to an address. Thus, keys can vary by address range, blocks, etc.

A permutation circuit 706 can include a scrambling section 730 and a de-scrambling section 732. A scrambling section 730 can receive input write data (D), and can scramble such data according to a key (K) received from key select section 722. Conversely, de-scrambling section 732 can receive scrambled data from memory cell array 702 and can de-scramble such data to derive read output data (Q). In particular embodiments, sections 730 can provide pseudorandom bit permutations. However, any suitable encryption technique can be employed that provides a desired level of variation in bit values.

As noted above, scrambling of bit values to provide more even wear of bit locations can be implemented according to any suitable method. In one particular embodiment, scrambling/de-scrambling sections 730/732 can utilize a Feistel type network. One such example is shown in FIGS. 8A and 8B.

FIG. 8A shows a scrambling section 830 that can be included in embodiments. A write data value (DIN) can be divided into a less significant portion (LSBs) and more significant portion (MSBs), and encrypted by the network according to key value KEY, having portions K1, K2 . . . Kr. The encryption network can have adders 836 and pseudorandom functions 834, and can generate a scrambled array write value (Dwrite). The pseudorandom nature of bit values can help ensure memory cells do not develop high wear/use characteristics along physical divisions of memory cells, as shown in FIG. 16.

FIG. 8B shows a de-scrambling section 832 corresponding to that of FIG. 8A. A scrambled array output value (Dread) from a memory cell array can be divided into a less significant portion (LSBs) and more significant portion (MSBs), and de-encrypted by the network according to the key value KEY used to originally encrypt the data. An unscrambled version of the data can be provided as read data (QOUT).

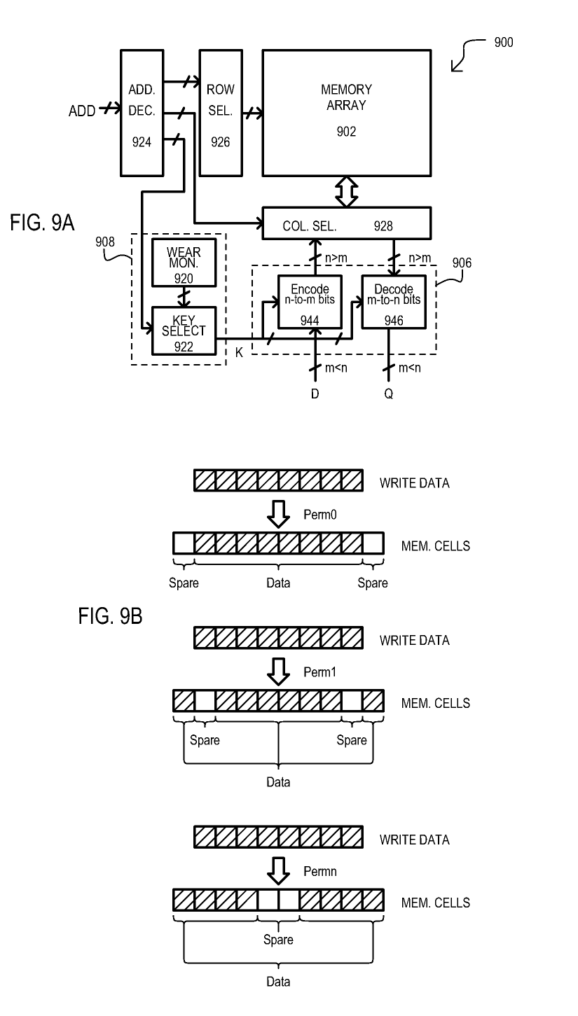

Embodiments above have shown permutation approaches in which bit widths of data values from a memory cell array can have the same bit width as received data values. However, in other embodiments, a permutation circuit can write data values into a memory cell array having a greater bit width than a received data values. That is, a permutation circuit can encode write data values of m-bits into data values of n-bits, where n>m. One such embodiment is shown in FIG. 9A.

FIG. 9A shows a memory device 900 according to another embodiment. A memory device 900 can include sections like those of FIG. 7, and such like items are referred to by the same reference character.

Memory device 900 differs from that of FIG. 7 in that a permutation circuit 906 can include an encode section 944 and a decode section 946. An encode section 944 can receive input write data (D) of m-bits, and encode such values into n-bit values to be written into memory cell array 902 (where n>m). In the embodiment shown, encoding can vary according to a key (K). However, in an alternate embodiment, an encoding can be of a fixed type that distributes bit values over a greater range than a standard data format (like that of FIG. 16). A decoding section 946 can receive n-bit data values, and decode them back into m-bit values, for output as read data (Q).

While FIG. 9A shows an embodiment in which input data values are encoded into larger write values, in other embodiments, input data values of m-bits can be written into differing locations of n-bits (where n>m). That is, data values are mapped to storage locations with extra bits. The location of the extra bits can change with each permutation, resulting in “wear redundancy”.

FIG. 9B is a diagram showing wear redundancy operations according to one very particular embodiment. As shown, with each different permutation (Perm0, Perm1, Perm2), data positions (Data) and spare positions (Spare) can change.

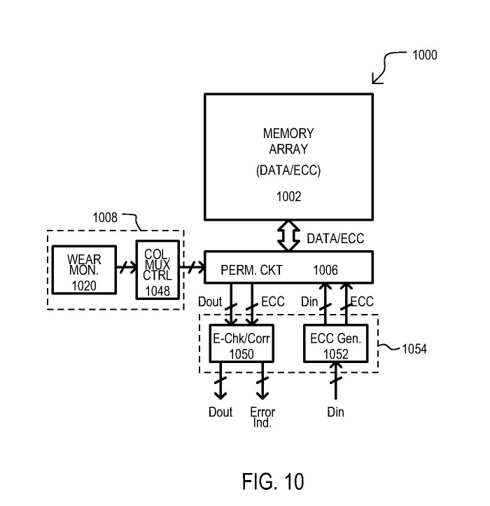

Embodiments can also vary bit distribution by changing position of different data types. In some embodiments, a memory device can include error detection and/or correction codes (hereinafter error codes) corresponding to stored data values. A position of error codes with respect to corresponding data values can be permuted to change bit distributions. One such embodiment is shown in FIG. 10.

FIG. 10 shows a memory device 1000 according to one embodiment that can shift a position of error codes with respect to corresponding data values, to permute data values written into a memory cell array. A memory device 1000 can include a memory cell array 1002, monitor circuit 1008, a permutation circuit 1006, and an error circuit 1054. A memory cell array 1002 can include solid electrolyte based memory cells, as described herein, or equivalents.

In the embodiment shown, a monitor circuit 1008 can include a wear monitor section 1020 and a multiplexer (MUX) controller 1048. A wear monitor section 1020 can make a determination that a permutation is to occur. Such a determination can be according to embodiments described herein, or equivalents. A MUX controller 1048 can control how a permutation circuit 1006 shifts bits of error codes with respect to corresponding data values.

A permutation circuit 1006 can shift bit locations of write data and corresponding error codes to permute bit locations of data written into a memory cell array 1002. Conversely, permutation circuit 1006 can unshift such data values to separate error codes from data values, to provide such data for a readout operation. As shown in FIG. 10, permutation circuit 1006 can receive input data values (Din) with corresponding error codes (ECC) and generate an intermixed value (DATA/ECC), which includes error code bits intermixed with corresponding data values. Further, permutation circuit 1006 can receive intermixed data values (DATA/ECC) and can output a separate data value (Dout) (which contains no ECC bits) and error code value (ECC) (which does not contain any data value bits).

An error circuit 1054 can include an error check and/or correct section 1050 and an error code generation section 1052. An error check/correct section 1050 can receive write data values (Din) and can generate error codes (ECC). Data values (Din) and corresponding error codes (ECC) can then be forwarded to memory cell array 1002. In some embodiments, error codes can be error detect codes, which can be used to detect, but not correct errors in a corresponding data value. In other embodiments, error codes can be error detect and correct codes, which can be used to detect and correct errors in the corresponding data value.

An error check/correct section 1050 can receive data values (Dout) and corresponding error codes (ECC) from memory cell array 1002, and can perform an error detect operation on the data value. In some embodiments, error correction can also be performed. In the particular embodiment shown, an error check/correct section 1050 can also provide an error indication (Error Ind.) in the event an error is detected.

It is noted that in some embodiments, a memory device 1000 may not include an error circuit 1054, and data and error codes can be provided to the memory device by another device of a larger system.

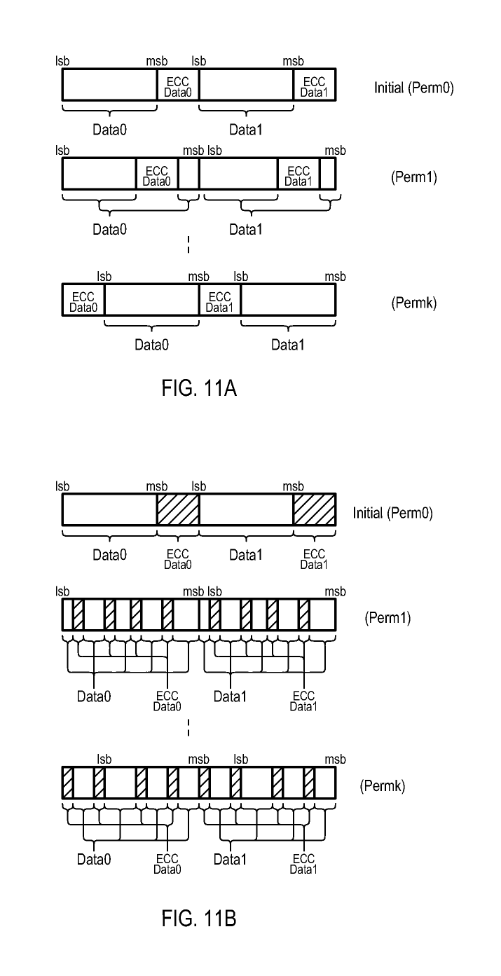

FIGS. 11A and 11B are diagrams showing examples of bit permutations that can be included in an embodiment like that of FIG. 10.

FIG. 11A shows an error code permutation approach in which a multi-bit error code can be shifted as a unitary block through bit locations of the corresponding data and error code. FIG. 11A shows an initial state (Initial Perm0), in which data values (Data0/1) occupy contiguous bit locations next to corresponding error codes (ECC Data0/ECC Data1), which also occupy contiguous bit locations.

A first permutation (Perm1) can shift ECC data to the left and a portion of the corresponding data value to the right.

A last permutation (Permk) can shift ECC data to least significant bit (lsb) locations, with a corresponding data value occupying more significant positions.

FIG. 11B shows an error mode permutation approach in which an error code can be intermixed with data values in different permutations. FIG. 11B shows an initial state (Initial Perm0) like that of FIG. 11A. Subsequent permutations (Perm1 to Permk) can intermix ECC values with data values as shown. In particular embodiments, such mixing can occur in a pseudorandom fashion.

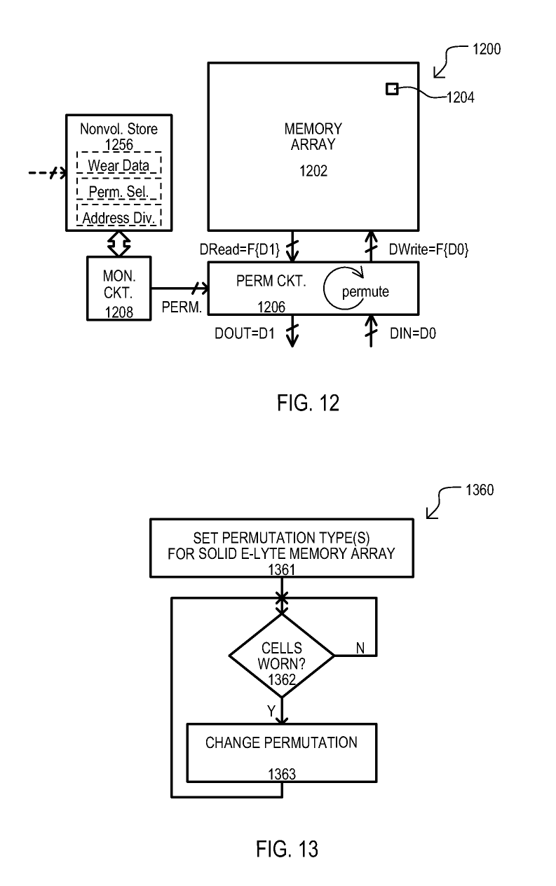

As noted above, in some embodiments, memory devices can apply permutation values that change over time, or vary between memory cell groups (e.g., along address lines or on a block-by-block basis). In some embodiments, should a memory device lose power, or experience a reset event, a permutation process can return to an initial state. However, in other embodiments, permutation states can be maintained and updated in a nonvolatile memory. Thus, in a power-on, reset or similar event, the permutation process can resume from the saved state. FIG. 12 shows an embodiment having such storage capability.

FIG. 12 shows a memory device 1200 like that of FIG. 1, and like sections can operate in the same or an equivalent fashion. Unlike FIG. 1, FIG. 12 also includes nonvolatile store 1256. A nonvolatile store 1256 can store data that selects permutation type(s) to be applied to data values. In the very particular embodiment, such data can include wear data (Wear Data) which can record how all or portions of memory cell array 1202 have been used, permutation select data (Perm. Sel.) which can identify particular permutation(s) to be used, and address data (Address Div.) which can identify portions of memory cell array 1202 that are subject to different permutations.

While a nonvolatile store 1256 is shown separate from memory cell array 1202, in some embodiments, a nonvolatile store 1256 can be part of the memory cell array 1202.

Embodiments above have shown devices and methods according to various embodiments. Additional method embodiments will now be described with reference to a number of flow diagrams.

FIG. 13 is a flow diagram showing a method 1360 according to one embodiment. A method 1360 can include setting one or more permutation types for a solid electrolyte memory array 1361. Such an action can include establishing a first permutation type for one or more different sections of a memory array. Such permutations can include any of those shown herein or equivalents. A method 1360 can then determine if cells are worn 1362. Such an action can include determining if cells have been accessed a certain amount of time and/or have been operating for a certain amount of time. Such an action can take various other factors into account, such as power supply level of a memory device, operating temperature, and/or application. If cells are determined not be worn (N from 1362), a method can return to monitoring cells for a wear level. If cells are determined to be worn (Y from 1362), a method 1360 can change a permutation 1363. Such an action can include changing a permutation according to a predetermined progression, mixing (or encoding) bits. Such an action can include changing permutations for different regions of the memory cell array.

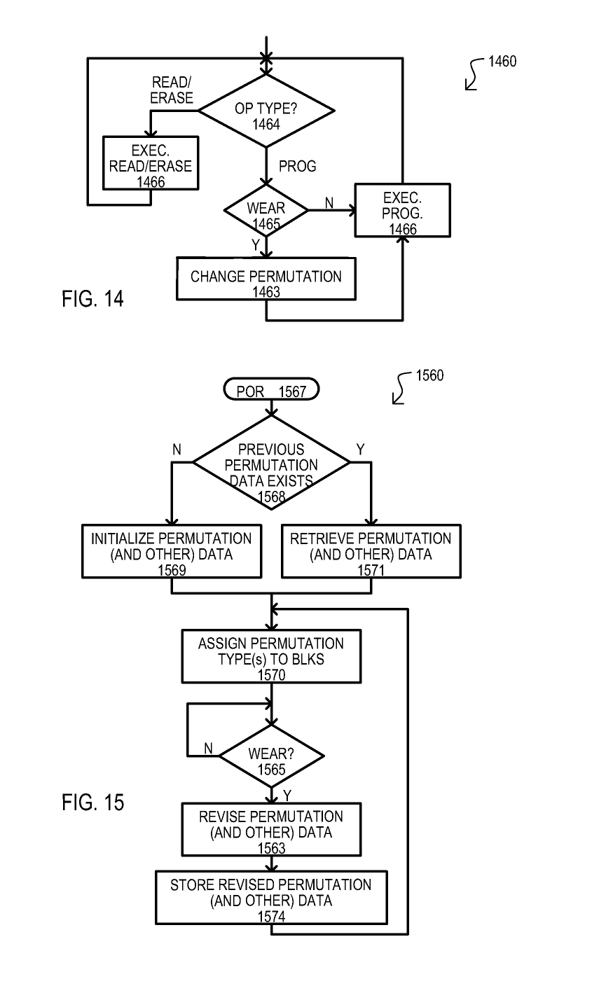

While some embodiments can advance a permutation type based on any accesses to a memory cell array, in other embodiments permutation changes may occur only in response to particular types of operations. That is, some operations (e.g., read) will not trigger a permutation change. One such embodiment is shown in FIG. 14.

FIG. 14 is a flow diagram of a method 1460 according to one embodiment. In FIG. 14, it is assumed that a memory device can perform: read operations, which can sense data values; erase operations which can program all, or a group, of memory elements to a common impedance state (e.g., a high impedance); and program operations which can selectively program memory elements to a different impedance state (e.g., low impedance) according to write data.

A method 1460 can include determining an operation type 1464. If an operation is a read or erase operation (READ/ERASE from 1464), such an operation can be executed 1466. If an operation is a program operation (PROG from 1464), a method can make a wear determination on memory elements. If such elements are determined not to be worn (N from 1465), the program operation can be executed 1466. However, if the elements are determined to be worn, a permutation change can occur 1463. The program operation can then be executed, but with the new permutation on bit values 1466.

FIG. 15 is a flow diagram of a method 1560, according to one embodiment, in which permutation data (i.e., data that establishes a type of permutation performed by the memory device) is stored. This can enable a last permutation type to be applied in the event operations are interrupted, such as in the case of a power-on or reset type event.

FIG. 15 shows the occurrence of a predetermined event 1567 which can trigger the method 1560. In the particular embodiment shown, the predetermined event can be a power-on or reset event (POR). In the occurrence of such an event, a method 1560 can determine if previous permutation data exists 1568 (i.e., such data was previously stored). If such data does not exist (N from 1568), permutation data can be initialized 1569. Such an action can include initializing data for executing permutations of bit data positions as described herein, or equivalents. After initializing permutation data, permutation types can then be applied to a memory cell array. In the embodiment shown, this can include assigning one or more permutation types to blocks of a memory cell array 1570.

If previous permutation data does exists (Y from 1568), such data can be retrieved 1571. Based on retrieved permutation data, permutation types can be assigned to blocks of the memory cell array 1570.

Upon reaching a predetermined wear limit (Y from 1565), a method can revise permutation data 1563 and store the revised permutation data 1574. In some embodiments, such an action can include storing the data in a nonvolatile fashion. In other embodiments, such data can be stored at locations in larger system containing the memory device. A method 1560 can then assign such revised permutation values to blocks of the memory array 1570.

It should be appreciated that in the foregoing description of exemplary embodiments, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

It is also understood that the embodiments of the invention may be practiced in the absence of an element and/or step not specifically disclosed. That is, an inventive feature of the invention can be elimination of an element.

Accordingly, while the various aspects of the particular embodiments set forth herein have been described in detail, the present invention could be subject to various changes, substitutions, and alterations without departing from the spirit and scope of the invention.

What is claimed is:

1. A memory system, comprising:
a plurality of memory elements each comprising a memory element having at least one layer programmable between at least two different impedance states;
a data input configured to receive multi-bit write data values; and
a permutation circuit coupled between the memory elements and the data input, and configured to repeatedly permute the multi-bit write data values prior to writing such data values into the memory elements.

2. The memory system of claim 1, wherein:
the permutation circuit comprises bit-shift circuits configured to shifts bit positions in a predetermined direction for different permutation types.

3. The memory system of claim 1, further including:
a wear monitor circuit configured to generate wear indications in response to predetermined wear conditions; and
the permutation circuit is configured to alter a permutation type in response to at least one wear indication.

4. The memory system of claim 3, wherein:
the memory elements are organized into a number of blocks; and
the permutation circuit is configured to apply different permutations to different blocks in response to at least one wear indication.

5. The memory system of claim 4, wherein:
the permutation circuit is configured to advance to a next permutation once all blocks have been subject to a previous permutation.

6. The memory system of claim 1, further including:
a wear monitor circuit configured to generate wear indications in response to predetermined wear conditions; and
the permutation circuit is configured to assign one permutation type to addresses in a first range, and another permutation type to addresses in a second range; wherein
the first and second address ranged change in response to the wear indications.

7. The memory system of claim 6, further including:
the memory elements are physically organized into a number of blocks; and
an address translation circuit configured to selectively isolate at least one block from accesses according to a particular order, so that each block functions as a spare block in a wear rotation; wherein
the first address range comprises blocks having a physical address less than the at least one spare block, and the second address range comprises blocks having a physical address greater than the at least one spare block.

8. The memory system of claim 1, wherein:
the permutation circuit comprises bit scramble circuits configured to scramble bit positions in according to key values.

9. The memory system of claim 1, further including:
an error circuit configured to generate an error code comprising at least one bit in response to received multi-bit write data values; and
the permutation circuit is configured to permute bit positions of the error code and the corresponding write data value.

10. A method, comprising:
permuting bits of write data written into memory cells having at least one programmable impedance layer; and
repeatedly changing a permutation type in response to a wear limit for at least a portion of the memory cells.

11. The method of claim 10, wherein:
permuting bits is selected from the group of: shifting bit positions in a predetermined direction, scrambling bit positions in response to key values, encoding m-bit values into larger n-bit values, and writing m-bit values into larger n-bit locations, with some of the n-bits being unused spare locations.

12. The method of claim 10, wherein:
permuting bits includes applying different permutation types to different memory cell address ranges.

13. The method of claim 10, wherein:
permuting bits includes mixing data bit positions with bit positions of a corresponding error code; wherein
the error code is selected from the group of: an error detection code used to detect an error in a data value and an error correction value used to correct an error in a data value.

14. The method of claim 10, wherein:
the memory cells are organized into blocks; and
permuting bits includes permuting bits on a block-by-block basis.

15. The method of claim 14, further including:
sequentially designating at least one block as a spare block that is not accessed for read and write operations; and
permuting bits includes
applying one permutation type to blocks having physical addresses below that of a current spare block, and
applying another permutation type to blocks having physical addresses above that a current spare block.

16. The method of claim 10, wherein:
changing the permutation type includes changing the permutation type applied to at least one group of memory cells in response to a wear indication corresponding to the group of memory cells.

17. A memory system, comprising:
a plurality of memory elements each comprising a memory layer having at least one memory layer programmable between at least two different impedance states;
a permutation circuit configured to permute bits of write data written into the memory elements in response to permutation select data; and
a nonvolatile store to store the permutation select data.

18. The memory system of claim 17, further including:
a monitor circuit configured to generate different permutation select values in response to wear of the memory device, and write a current permutation value into the nonvolatile store.

19. The memory system of claim 17, wherein:
the permutation circuit comprises a plurality bit mapping circuits, each bit mapping circuit receiving write data values of m-bits, and outputting permuted write data values of m-bits having bit positions that vary from the write data in response to the permutation select data.

20. The memory system of claim 17, wherein:
the permutation circuit comprises a plurality bit mapping circuits, each bit mapping circuit receiving write data values of m-bits, and outputting permuted write data values of n-bits having bit positions that vary from the write data in response to the permutation select data, where n>m.
